(19) United States
(12) Patent Application Publication
(10) Pub. No.: US 2014/0266535 A1
(43) Pub. Date: Sep. 18, 2014

(54) LOW LOSS INDUCTOR WITH OFFSET GAP AND WINDINGS

(71) Applicant: HIQ SOLAR, INC., Santa Clara, CA (US)

(72) Inventor: Andre P. WILLIS, PALO ALTO, CA (US)

(73) Assignee: HIQ SOLAR, INC., Santa Clara, CA (US)

(21) Appl. No.: 14/206,511

(22) Filed: Mar. 12, 2014

Related U.S. Application Data
(60) Provisional application No. 61/782,457, filed on Mar. 14, 2013.

(51) Int. Cl. H01F 27/24; H01F 41/06

(52) U.S. Cl. CPC H01F 27/24; H01F 41/06
USPC 336/178; 29/605

(57) ABSTRACT

A low loss power inductor and method for making same. A magnetic core is constructed of one or more E-shaped and l-shaped portions. Each E-shaped portion includes top, middle and bottom bars, and an open edge adjacent an l-shaped portion with a gap between the middle bar and the l-shaped portion. Conductive and insulated layers having mutually adjacent surfaces are coiled about the one or more middle bars. The width of the conductive layer is no greater than the length of the middle bars and is less than or equal to the width of the insulated layer.

### RELATED APPLICATIONS

This application claims priority to and the benefit of U.S. Patent Application 61/782,457, entitled “Low Loss Inductor Windings Using Offset Gap, Offset Windings,” which was filed on Mar. 14, 2013, the disclosure of which is incorporated herein by reference.

### BACKGROUND

The present invention relates to inductors, and in particular, to inductors for storing energy in high power applications.

Inductors are a key component used in power electronics for storing energy. High efficiency power conversion requires inductors with low loss.

The conventional way of designing power inductors is to use a ferrite core as shown in FIG. 1(a). The classic E shape (101) has the center pillar of ferrite slightly shorter than top and bottom pillars (102), ensuring that when two E cores (103, 104) are placed together back to back FIG. 1(b) a center air gap is produced (105). This air gap is where most energy is stored within the device.

The next step in constructing the inductor is to wind a length of insulated copper around the core. In power electronics this is often copper foil, as shown in FIG. 2(a). Here a sheet of copper (204) is wrapped (202) along with an insulating sheet (203) around the core (201) of the inductor including the air gap.

### SUMMARY

In accordance with the presently claimed invention, a low loss power inductor and method for making same are provided. A magnetic core is constructed of one or more E-shaped and l-shaped portions. Each E-shaped portion includes top, middle and bottom bars, and an open edge adjacent an l-shaped portion with a gap between the middle bar and the l-shaped portion. Conductive and insulated layers having mutually adjacent surfaces are coiled about the one or more middle bars. The width of the conductive layer is no greater than the length of the middle bars and is less than or equal to the width of the insulated layer.

In accordance with one embodiment of the presently claimed invention, a low loss power inductor includes:

a magnetic core including an E-shaped portion with top, middle and bottom bars, and an l-shaped portion adjacent an open edge of the E-shaped portion with a gap between the middle bar and the l-shaped portion; and

conductive and insulated layers coiled about the middle bar, wherein the conductive and insulated layers include
a conductive layer having first width and length dimensions substantially parallel and orthogonal, respectively, to a length of the middle bar, wherein the first width is no greater than the length of the middle bar, and
an insulated layer adjacent a surface of the conductive layer and having second width and length dimensions substantially parallel to the first width and length dimensions, respectively, wherein the second width is equal to or greater than the first width.

In accordance with another embodiment of the presently claimed invention, a low loss power inductor includes:

a magnetic core including a plurality of E-shaped portions, with corresponding pluralities of top, middle and bottom bars, disposed in a successively parallel arrangement, and a plurality of l-shaped portions disposed in a successively parallel arrangement adjacent corresponding open edges of the plurality of E-shaped portions with a gap between the plurality of middle bars and the plurality of l-shaped portions; and

conductive and insulated layers coiled about the plurality of middle bars, wherein the conductive and insulated layers include
a conductive layer having first width and length dimensions substantially parallel and orthogonal, respectively, to a length of the plurality of middle bars, wherein the first width is no greater than the length of the plurality of middle bars, and
an insulated layer adjacent a surface of the conductive layer and having second width and length dimensions substantially parallel to the first width and length dimensions, respectively, wherein the second width is equal to or greater than the first width.

In accordance with another embodiment of the presently claimed invention, a method for making a low loss power inductor includes:

providing a magnetic core including an E-shaped portion with top, middle and bottom bars, and an l-shaped portion adjacent an open edge of the E-shaped portion with a gap between the middle bar and the l-shaped portion; and

coiling conductive and insulated layers about the middle bar, wherein the conductive and insulated layers include
a conductive layer having first width and length dimensions substantially parallel and orthogonal, respectively, to a length of the middle bar, wherein the first width is no greater than the length of the middle bar, and
an insulated layer adjacent a surface of the conductive layer and having second width and length dimensions substantially parallel to the first width and length dimensions, respectively, wherein the second width is equal to or greater than the first width.

### BRIEF DESCRIPTION OF THE DRAWINGS

FIGS. 1(a)-1(b) illustrate conventional ferrite cores for power inductors.

FIG. 1(c) illustrates magnetic field flux lines within ferrite core air gaps.

FIG. 1(d) illustrates a ferrite core for power inductors in accordance with an exemplary embodiment of the presently claimed invention.

FIGS. 2(a)-2(b) illustrate conventional copper foil designs for power inductors.

FIG. 2(c) illustrates an offset copper foil design for power inductors in accordance with an exemplary embodiment of the presently claimed invention.

FIGS. 3(a)-3(d) illustrates stacked ferrite cores for power inductors in accordance with exemplary embodiments of the presently claimed invention.

### DETAILED DESCRIPTION

As discussed in more detail below, innovations in accordance with the presently claimed invention include: inductive component construction using offset placement of copper foil producing a low loss high current inductor using off-the-shelf magnetic cores, and stacking of off-the-shelf cores for storing more energy in a low profile inductor with reduced size, weight and conduction losses.

### Method 1—Offset Windings

One issue with the conventional approach is that the magnetic field flowing around the core and through air gap does not stay contained within the immediate confines of the air gap FIG. 1(c) (106) but fringes outside (107). This causes eddy currents in copper resulting in loss and heat, and is undesirable.

A solution to this issue is shown on FIG. 2(b). In this approach a ‘V’ is cut out of the copper foil (206); this has the effect of keeping copper away from the fringing field around the air gap and produces a lower loss component. However, cutting the copper is fiddly and time consuming, and sharp edges that would cut the insulator must be carefully dealt with.

The approach described here uses the core design shown in FIG. 1(d) and FIG. 2(c) (207), also called ‘EI’. The air gap is offset. Cores like this are easily and cheaply available. The key innovation is shown in FIG. 2(c), which is to narrow the strip of copper foil and to wind with offset placement (208, 209). This has the effect of keeping the copper foil away from the fringing field associated with the air gap, but with lower labor and tooling costs and no issues with sharp edges. Relative to the conventional approach (FIG. 2(a)) the component is high power with low losses, and relative to the V cut approach it has the same low losses but at lower cost.

### Method 2—Stacking Cores

The second new approach is stacking of EI cores. FIG. 3(a) shows a representative EI core. Stacking 2 or more cores next to each other, it is possible to have them act like a single longer core. This allows a low profile topology while increasing the amount of stored energy. The most obvious way of storing more energy would be to take two or more inductors connected in series. By stacking cores we are achieving the same increase in energy stored while occupying less physical space and weight and also having less electrical resistance. This is because the value of inductance increases linearly with the number of cores, but the resistance (and therefore conduction losses) increase at a lower rate. An example with four cores (302, 303, 304, 305) is shown in FIG. 3(b), and photographs of components with 2 (306, 307) and 4 (308, 309, 310, 311) cores are shown in (c) and (d) respectively.

Various other modifications and alternations in the structure and method of operation of this invention will be apparent to those skilled in the art without departing from the scope and the spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. An apparatus including a low loss power inductor, comprising:
a magnetic core including an E-shaped portion with top, middle and bottom bars, and an l-shaped portion adjacent an open edge of said E-shaped portion with a gap between said middle bar and said l-shaped portion; and
conductive and insulated layers coiled about said middle bar, wherein said conductive and insulated layers include
a conductive layer having first width and length dimensions substantially parallel and orthogonal, respectively, to a length of said middle bar, wherein said first width is no greater than said length of said middle bar, and
an insulated layer adjacent a surface of said conductive layer and having second width and length dimensions substantially parallel to said first width and length dimensions, respectively, wherein said second width is equal to or greater than said first width.

2. The apparatus of claim 1, wherein all of said first width is coiled about said middle bar, and a portion of said second width is coiled about said gap.

3. The apparatus of claim 1, wherein all of said conductive layer is coiled about said middle bar, and a portion of said insulated layer is coiled about said gap.

4. The apparatus of claim 1, wherein at least one of said top and bottom bars abuts said l-shaped portion.

5. The apparatus of claim 1, wherein said top and bottom bars have top and bottom lengths, respectively, and said middle bar has a middle length less than at least one of said top and bottom lengths.

6. The apparatus of claim 1, wherein said E-shaped and l-shaped portions comprise a ferrite material.

7. An apparatus including a low loss power inductor, comprising:
a magnetic core including a plurality of E-shaped portions, with corresponding pluralities of top, middle and bottom bars, disposed in a successively parallel arrangement, and a plurality of l-shaped portions disposed in a successively parallel arrangement adjacent corresponding open edges of said plurality of E-shaped portions with a gap between said plurality of middle bars and said plurality of l-shaped portions; and
conductive and insulated layers coiled about said plurality of middle bars, wherein said conductive and insulated layers include
a conductive layer having first width and length dimensions substantially parallel and orthogonal, respectively, to a length of said plurality of middle bars, wherein said first width is no greater than said length of said plurality of middle bars, and
an insulated layer adjacent a surface of said conductive layer and having second width and length dimensions substantially parallel to said first width and length dimensions, respectively, wherein said second width is equal to or greater than said first width.

8. The apparatus of claim 7, wherein all of said first width is coiled about said plurality of middle bars, and a portion of said second width is coiled about said gap.

9. The apparatus of claim 7, wherein all of said conductive layer is coiled about said plurality of middle bars, and a portion of said insulated layer is coiled about said gap.

10. The apparatus of claim 7, wherein at least one of said pluralities of top and bottom bars abuts said plurality of l-shaped portions.

11. The apparatus of claim 7, wherein said pluralities of top and bottom bars have top and bottom lengths, respectively, and said plurality of middle bars has a middle length less than at least one of said top and bottom lengths.

12. The apparatus of claim 7, wherein said pluralities of E-shaped and l-shaped portions comprise a ferrite material.

13. A method for making a low loss power inductor, comprising:
providing a magnetic core including an E-shaped portion with top, middle and bottom bars, and an l-shaped portion adjacent an open edge of said E-shaped portion with a gap between said middle bar and said l-shaped portion; and
coiling conductive and insulated layers about said middle bar, wherein said conductive and insulated layers include
a conductive layer having first width and length dimensions substantially parallel and orthogonal, respectively, to a length of said middle bar, wherein said first width is no greater than said length of said middle bar, and
an insulated layer adjacent a surface of said conductive layer and having second width and length dimensions substantially parallel to said first width and length dimensions, respectively, wherein said second width is equal to or greater than said first width.

14. The method of claim 13, wherein said all of said first width is coiled about said middle bar, and a portion of said second width is coiled about said gap.

15. The method of claim 13, wherein all of said conductive layer is coiled about said middle bar, and a portion of said insulated layer is coiled about said gap.

16. The method of claim 13, wherein at least one of said top and bottom bars abuts said l-shaped portion.

17. The method of claim 13, wherein said top and bottom bars have top and bottom lengths, respectively, and said middle bar has a middle length less than at least one of said top and bottom lengths.

18. The method of claim 13, wherein said E-shaped and l-shaped portions comprise a ferrite material.
